(19) United States
(12) Patent Application Publication
(10) Pub. No.: US 2006/0074929 A1
(43) Pub. Date: Apr. 6, 2006

(54) Multiple document file tab channel

(75) Inventors: Jason J. Weber, Kirkland, WA (US); Chris J. McGuire, Monroe, WA (US); Janet M. Caler, Bellevue, WA (US); Rahul S. Kumar, Kirkland, WA (US); Karl H. Melder, Seattle, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/955,036

(22) Filed: Sep. 30, 2004

(51) Int. Cl. G06F 7/00

(52) U.S. Cl. 707/100

(57) ABSTRACT

Disclosed is a unique system and method that facilitates more efficient navigation and viewing of multiple open objects such as files, documents, pages, sheets, etc. The systems and methods make use of a navigation bar or tab channel. The tab channel can comprise a shifting region and optionally, a static region—the static region being positioned to the left of the shifting region. As files are opened, for example, the file name is appended to the left side of the tab channel. When another file is opened, it is appended to the left side of the tab channel, thus pushing the first file to the right. This proceeds so that the most relevant files are viewable in the tab channel. An on-screen menu is also maintained that includes all open files in an ordered manner. Thus, a file name no longer on the tab channel can be accessed from the menu—and then reinserted into the tab channel if viewing of its contents is desired.

### TECHNICAL FIELD

The subject invention relates generally to document navigation within a display space and in particular, to enhanced viewing and navigation of multiple documents in part by their organization on a user interface.

### BACKGROUND OF THE INVENTION

Aside from computer programs typically sold for general consumer use, various types of businesses, educational institutions, and even individuals can have specific needs when it comes to processing, storing, and accessing different types of information. To satisfy their needs, many of them often rely on customized applications that meet their specifications and often turn to program developers, who are called upon to design and/or create specialized applications. Over the past several years, the need for creating business-specific computing programs has increased due in large part to the many new types of services or businesses in the marketplace. However, despite the number of improvements that have been made to program development tools, conventional techniques continue to present challenges, obstacles, and/or inconveniences to developers, resulting in less efficiency during the creation and coding processes. For example, many programs are composed of thousands of files, and navigation through multiple files or documents can be rather cumbersome, particularly when working with a large number of resources at about the same time. Dozens of opened files, documents, pages, etc. can be difficult or time-consuming to locate when their positions on a menu, for example, are arbitrarily determined. Hence, conventional techniques have yet to provide users with an effective means for such viewing when working they are working with more than just a few open documents, files, pages, or sheets.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention relates to a system and/or methodology that facilitate more efficient navigation of multiple open objects through the use of a tab channel navigation bar. More specifically, as an object is opened for viewing within a display space, a tab having the object's name thereon can be positioned to the left side of the display space or navigation bar, and in particular, to the left of any other object present on the navigation bar. The previously opened object(s) can then be shifted to the right in the navigation bar. Because the viewable length of the navigation bar can be limited (to mitigate scrolling of the bar to reveal hidden object names), a set number of objects can be viewed—depending on the length of each tab. When the display space becomes full, one or more previously opened files can be dropped from the right side of the navigation bar but can remain accessible by way of a drop down resource menu. As a result, the most relevant objects can remain in view on the left of the navigation bar—meanwhile the least relevant objects can be dropped from the viewable display space, thereby mitigating tedious searching (for an object) and improving a user's overall navigation experience.

According to one aspect of the invention, the navigation of objects including but not limited to files, documents, pages, sheets, abstract views, etc. can be accomplished in part by the use of object indicators such as tabs arranged within a tab channel. When a file, for instance, is opened by the user, the file's name and type can be presented via a tab to facilitate quick and easy recognition of the file and/or its content. Color and/or icons or symbols can be incorporated as well on the tabs to further distinguish between different states or types of files and/or to facilitate grouping of related files. The tabs can also comprise functional components to facilitate carrying out an action with respect to the file such as save, save as, close, rename, make static, make shifting, etc. For example, if a particular file has been modified, the user can simply click a designated part of the tab to save the file or to select a “save” action from a list of available options directly on the tab (e.g., right click on the tab to reveal an options menu for that tab). Color can also be used to denote a file's status such as whether a file has been modified but not saved, not modified. Other (file) states can be available and employed as well.

According to another aspect of the subject invention, the viewable display space for the objects can include a channel in which navigation between file tabs can be performed. A window to view the content of an active file tab can also be a part of the display space. Tabs of inactive files (e.g., not selected for viewing) may remain in view in the channel. As mentioned above, as newer or more relevant file tabs fill the channel, older or less relevant file tabs can be shifted to the right and can eventually drop off from the channel. Though they are no longer viewable in the channel, these files can still be accessed for viewing by accessing a file menu or resource list also located on the user interface. In other words, such files can be added back to the channel for tab navigation when selected for viewing by the user.

The resource menu or list can be populated as new files are opened. When a new file is opened, the file can append to the left side of the channel as well as to the menu list. The menu list can arrange such files in an ordered manner. For example, the files can be listed alphabetically. Thus, files which were once less relevant but may now be more relevant to the user can be easily and quickly found. In accordance with yet another aspect of the subject invention, when a file must be accessed from the menu list (because it was bumped from the channel), the file re-enters the channel to the left of any other files in the channel. Moreover, files present in the channel can be indicative of relevancy or usefulness to the user at any particular time.

To the accomplishment of the foregoing and related ends, certain illustrative aspects of the subject invention are described herein in connection with the following description and the annexed drawings. These aspects are indicative, however, of but a few of the various ways in which the principles of the subject invention may be employed and the subject invention is intended to include all such aspects and their equivalents. Other advantages and novel features of the subject invention may become apparent from the following detailed description of the subject invention when considered in conjunction with the drawings.

### BRIEF DESCRIPTION OF THE DRAWINGS

FIG. 1 is a high level block diagram of a system that facilitates navigation between a large number of files or objects in accordance with an aspect of the subject invention.

FIG. 2 is a block diagram of a system that organizes files in a viewable display space according to relevancy as based on the user's needs in accordance with an aspect of the subject invention.

FIG. 3 illustrates an exemplary file tab channel in accordance with an aspect of the subject invention.

FIG. 4 illustrates an exemplary file tab channel comprising open File A in accordance with an aspect of the subject invention.

FIG. 5 illustrates an exemplary file tab channel comprising open files A and B, whereupon file B has been appended to the left of file A in accordance with an aspect of the subject invention.

FIG. 6 illustrates an exemplary file tab channel comprising files A and B and a drop down menu list also comprising files A and B for quick access to files A and B in accordance with an aspect of the subject invention.

FIG. 7 illustrates an exemplary file tab channel comprising newly opened file C to the left of file B, as noted in FIG. 6, in accordance with an aspect of the subject invention.

FIG. 8 illustrates an exemplary file tab channel including a view of a menu list in accordance with an aspect of the subject invention.

FIG. 9 illustrates a navigational maneuver and result therefrom with respect to an exemplary file tab channel in accordance with an aspect of the subject invention.

FIG. 10 illustrates the exemplary file tab channel of FIG. 9 after opening another file in accordance with an aspect of the subject invention.

FIG. 11 illustrates the exemplary file tab channel of FIG. 10 after another file has been opened in accordance with an aspect of the subject invention.

FIG. 12 illustrates the exemplary file tab channel of FIG. 11 after opening another file in accordance with an aspect of the subject invention.

FIG. 13 illustrates the exemplary file tab channel of FIG. 12 after yet another file has been opened in accordance with an aspect of the subject invention.

FIG. 14 illustrates the exemplary file tab channel of FIG. 13 after selecting to view a file presently in the tab channel in accordance with an aspect of the subject invention.

FIG. 15 illustrates the exemplary file tab channel of FIG. 14 after accessing a file from a menu list in accordance with an aspect of the subject invention.

FIG. 16 illustrates an exemplary user interface that facilitates navigating between a potentially large number of files or objects using a file tab channel in accordance with an aspect of the subject invention.

FIG. 17 illustrates an exemplary user interface incorporating the file tab channel in accordance with an aspect of the subject invention.

FIG. 18 is a flow chart illustrating an exemplary methodology that facilitates navigating between a potentially large number of files or objects using a tab channel in accordance with an aspect of the subject invention.

FIG. 19 is a flow chart illustrating an exemplary process that facilitates navigating between a potentially large number of files or objects using a tab channel in accordance with an aspect of the subject invention.

FIG. 20 is a flow chart illustrating an exemplary process that facilitates navigating between a potentially large number of files or objects using a tab channel in accordance with an aspect of the subject invention.

FIG. 21 illustrates an exemplary environment for implementing various aspects of the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the invention. It may be evident, however, that the invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject invention can incorporate various inference schemes and/or techniques in connection with navigating among a large number of objects (e.g., files, documents, pictures, figures, sheets, pages, clips, thumbnails, etc.) in a more efficient manner. For example, objects related by content, keywords, type, modified date/time, opened in the last w minutes, etc. can be (automatically) grouped into various collections as desired by a user. For better viewing and navigation of multiple collections, they can be separated into their respective viewing spaces (e.g., window, box . . . ) and made to float within the user's display screen.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The invention as described herein can be employed by any type of user, profession, and/or business for both personal and commercial benefit. For the ease of understanding, its utilization is discussed with respect to a software or application developer scenario.

In general, developers work with many, many files; and it may not be uncommon for a developer's project to encompass or involve a few hundred or a few thousand files. Due to the nature of creating new programs or improving older versions, developers can often find themselves constantly opening and navigating between several different files or file types at a time. Conventional “application tools” used by developers have been designed such that the application opens one file at a time per viewing window. Thus, when three files are opened, the developer or user typically must navigate between three windows. Other conventional techniques are designed according to a spatial model. Files are displayed in the order they are opened and can be moved around by the user. In either instance, the respective methods work well in applications where a user has only 3-4 files open. When just a few files are involved, these conventional techniques may be tolerable. However, when actively working with a large number of files as many developers do, this conventional technique becomes impracticable and ultimately yields a very poor user experience.

In general, when navigating among files, users often emphasize nine important file attributes:
what file can be seen on screen in the file channel;
order files are opened;
order files are viewed (MRU);
physical location on disk;
virtual location in solution hierarchy;
spatial relationship of surrounding files (e.g., time);
name of file;
relationship of files to tasks; and
state of file (e.g., opened or closed).

More recent models attempted to accommodate each of these nine attributes by providing an arrow-type spatial navigation system where sometimes files were opened on the right hand side of the channel, shifting the contents left, and sometimes files were opened next to related files (e.g., source & designer relationship). In the end, all nine of the above attributes were mixed and jumbled which created an unpredictable and confusing mess. Developers were left with lists of open or closed files arranged in an arbitrary and indeterminate manner, making locating files on the user interface a painful if not impossible task.

To mitigate such inefficiencies, the subject invention is optimized given that in software development, the order a user open files can be arbitrary and can correlate to the order the user may need that file for your current task. In addition, there can be a “many to many” relationship between files and tasks, and trying to create a spatial relationship of the order files are opened is artificial and arbitrary; thus, the file that you are currently working on is probably the user's most important file. The last five files that the user worked on are equally the user's second most important file. Finally, all other open files are equally the user's next most important file. This feels erroneous at first, but at a broad level this generally holds true.

The subject invention also considers and understands that when the user opens or selects a file through any means, the behavior of the file tab channel should remain consistent. Whether a file is open or not, whether it is part of the user's solution or not, and what designers and editors have the file open is peripheral to the user model. Hence, when the user performs an action that opens a file, it is imperative that what happens is predictable and consistent.

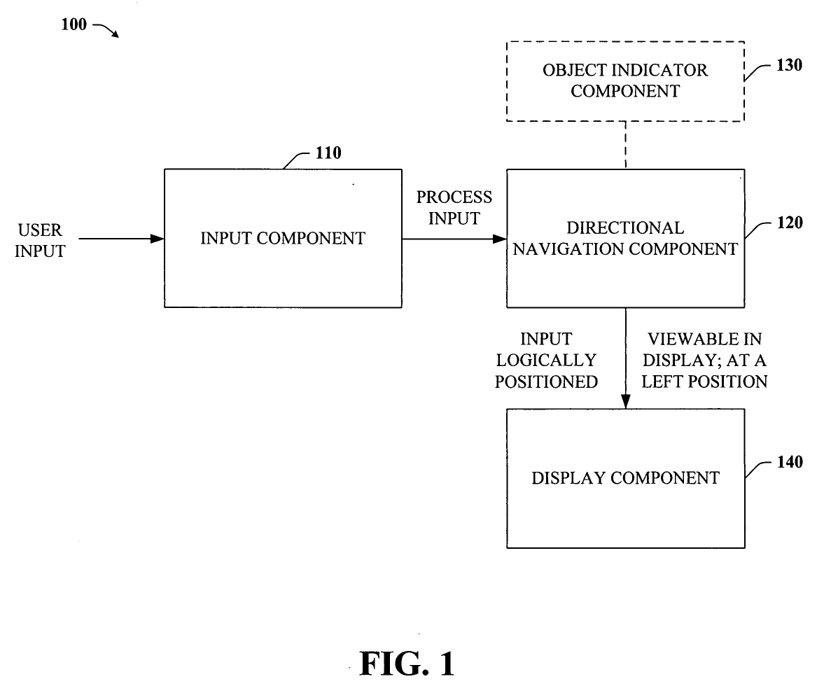

Accordingly, the subject invention employs a tab channel that can display at least the file names of any recently viewed files. In general, files in the tab channel can be arranged according to their relevance to the user—whereby the most relevant files are maintained to the left of the channel. Relevancy can be determined in part by the most recently accessed or used files. Thus, users can readily navigate between their most relevant files via the tab channel. Files determined to be less relevant are gradually dropped off of the tab channel but remain easily accessible from an on-screen menu (e.g., drop-down menu). Further discussion on this and other aspects of the invention can be found with respect to FIGS. 1-20 below.

Referring now to FIG. 1, there is a general block diagram of a navigation system 100 that facilitates viewing of and navigating between a large number of objects or files on a workspace. In particular, this can be accomplished in part by utilizing the tab channel. The tab channel allows a user to easily and quickly view at least a portion of multiple open objects. For example, rolling over a tab with a pointing device (e.g., mouse) can cause a caption of the content to pop-up. Clicking on a tab can activate the file for a more expanded view of its content (e.g., active file).

The system 100 includes an input component 110 that receives user input such as in the form of an object-open command (e.g., open file) or a object-select command (e.g., view file content), for example. The input can be processed for its content and communicated to a directional navigation component 120, by which placement of the object within the tab channel is determined. Operatively connected to the directional navigation component 120 is an object indicator component 130 that can be employed to determine the type(s) of content to include in the object tab. For instance, the tab can include at least one of the following: object name or object type. In addition, a color, icon, or symbol can be associated with the object to further characterize the content or some other quality or state of the object. For example, an object that has been modified but not saved can be given a red tab or an asterisk next to the name to readily indicate such information to the user.

Placement of objects in the tab channel can be determined based on the user's needs or preferences. In one approach, a first object can be opened and placed at the left side (e.g., left edge) of the channel. A second object can be subsequently opened and again placed at the left side of the channel, therefore pushing the first object to the right. The tab channel has a limited amount of tab space available; thus eventually, objects can fall off or be “removed” from the right side of the channel as additional objects are added to the channel.

Another approach involves a static region in the channel. The static region can include at least one object that the user wants to remain in the channel regardless of any other objects subsequently opened or introduced into the channel. Hence, files in the static regions remain fixed in the channel for more “permanent” availability or viewing. The remaining portion of the tab channel can be referred to as a shifting region. Objects visible in the shifting region can be considered temporary and thus, can change more frequently.

Looking again at FIG. 1, a display component 140 can display information to the user via a user interface such as the object tabs in the tab channel. In addition, the respective object content of an active object can be viewed by the user in a corresponding workspace or window.

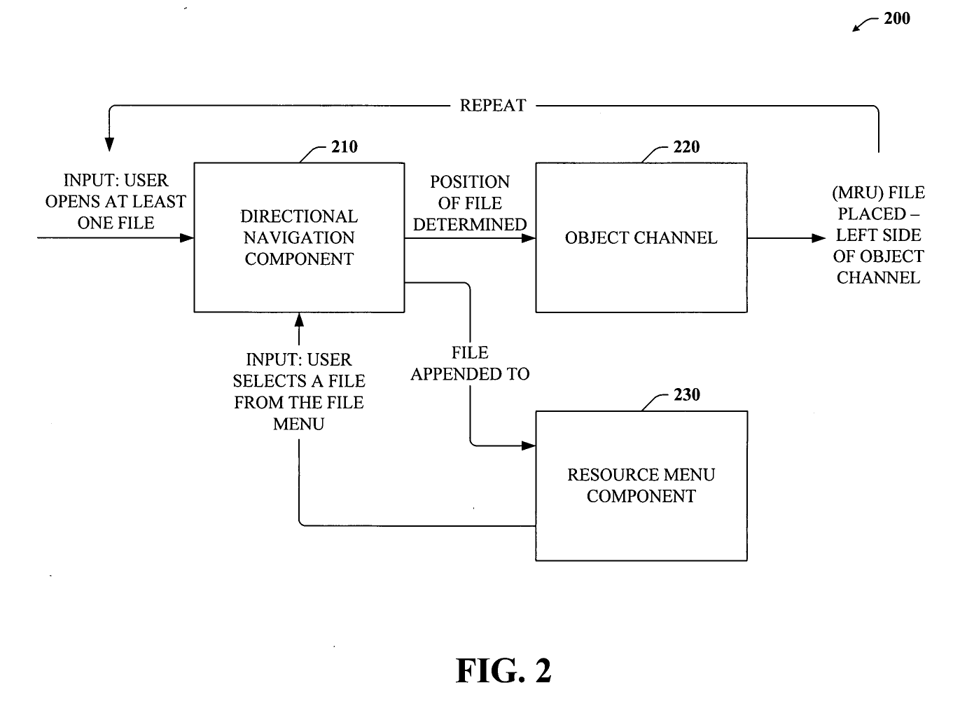

Referring now to FIG. 2, there is illustrated a block diagram of a navigational system 200 that optimizes the use of an object tab channel in connection with viewing and navigating between a large number of objects. The system 200 includes a directional navigation component 210 that receives user input such as in the form: “open at least a first file”. The directional navigation component 210 can determine the proper position of the file within an object tab channel 220 (e.g., object tab channel) based in part on the user's input or instructions (e.g., make static; make shifting). A default position for any file being introduced into the channel can be set to the left side of the channel. Therefore, the default status of a file entering the channel can be shifting.

A static region may be located at the far left of the channel, thus any other file entering the channel 220 can enter immediately right of the static channel but to the left of any other file in the channel 220 (e.g., in the shifting region of the channel). Files introduced into the shifting region of the channel 220 push other files in the channel to the right in the order in which they were introduced into the channel 220.

When the file is initially opened, the directional navigation component 210 can also append the file to a resource menu component 230 which comprises at least a subset of all files opened by the user during a given session, at the present time, or over a period of time. The resource menu component 230 can maintain a list of files in an ordered manner. For example, the files can be organized alphabetically for easy reference. The files can also be organized alphabetically and then sub-grouped by topic, content, time/date last accessed, date/time last modified, etc. Though not depicted in the figure, the resource menu component 230 can include only open files not viewable in the tab channel 220. Otherwise, the resource menu component can maintain substantially all open files—including those still viewable in the tab channel 220.

Files found in the resource menu component 230 but not in the tab channel 220 can also be accessed for viewing by the user. When this occurs, the file can once again be introduced into the tab channel 220 at the left side and cause any other files in the channel to shift right. Moreover, the tab channel essentially comprises the most relevant and/or the most recently used files as determined by the user.

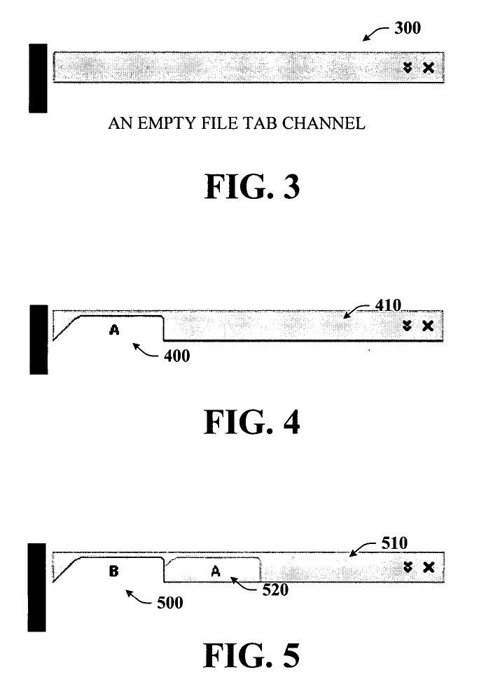

Various aspects of the subject invention as described above are further demonstrated by presenting a real world user scenario as shown in FIGS. 3-15 below. It should be appreciated that the exemplary tab channel used in this scenario is intentionally narrow to allow the user to view only three open files at a time. However, tab channels of various lengths or widths can be employed in a similar manner to carry out the subject invention.

Beginning with FIG. 3, there is illustrated an empty file tab channel 300. In FIG. 4, File A 400 is opened and is appended to the left side of the channel 410 and activated. FIG. 5 demonstrates the opening of File B 500. File B 500 is inserted on the left side of the channel 510 and File A 520 is pushed to the right.

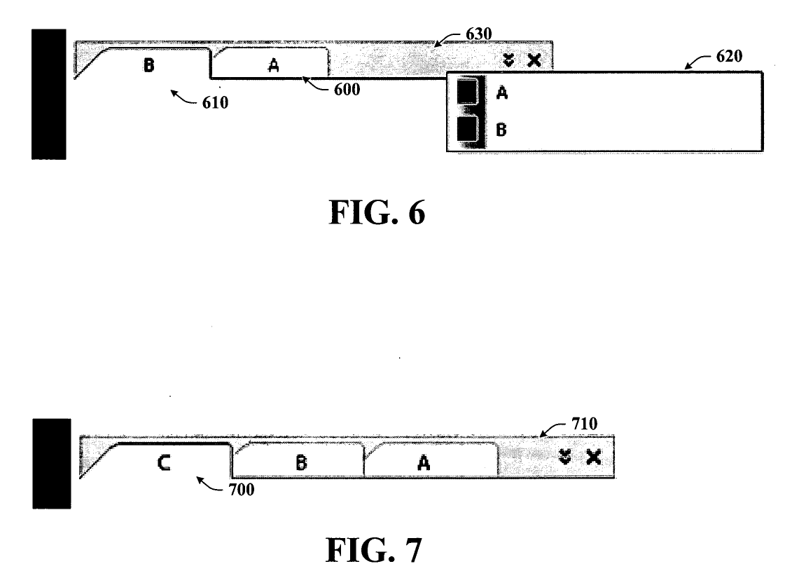

In FIG. 6, the schematic diagram shows that every open file 600 (A) and 610 (B) is alphabetically listed in a menu 620 even when all files are visible in the tab channel 630. In traditional systems, users were forced to think about whether their open file was visible in the tab channel or not. According to the subject invention, the menu lists every open file so that users are not burdened with making this distinction.

FIG. 7 illustrates the opening of File C 700. File C 700 is inserted on the left side of the channel 710, given focus (e.g., selected or made active), and the other tabs (e.g., A and B) are pushed to the right. It can be seen that the tabs are being inserted in MRU (most recently used) order, with the most recently opened file on the left.

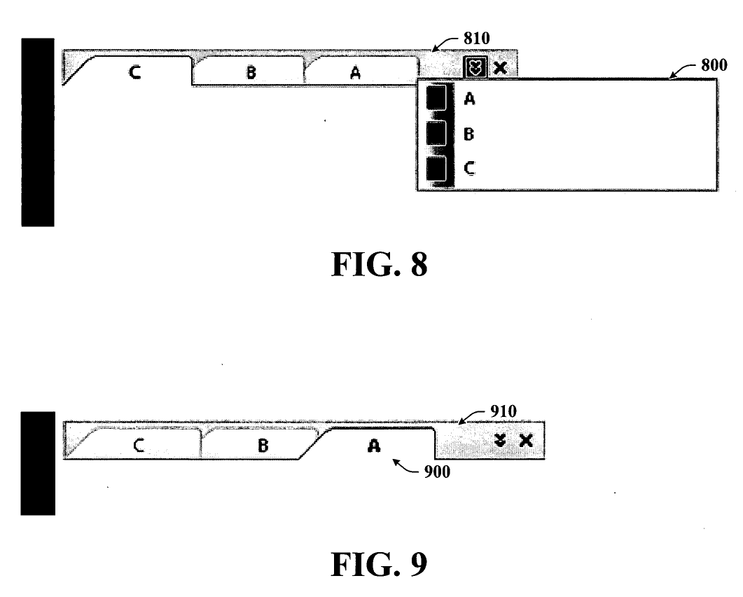

Moving on, FIG. 8 demonstrates that when a file menu 800 is dropped down, a list of every file can be seen—regardless of whether they are visible in the tab channel 810. In FIG. 9, when File A is chosen from the menu (e.g., FIG. 8, 800), the A tab 900 is activated in the channel 910. Note that File A 900 was not pushed to the front of the channel 910; it was just activated. In this instance, the channel is not a true MRU with the more recent tab being pushed to the front on the channel. The tab channel is the primary focal point in the IDE (integrated design environment) and it is desirable to limit unnecessary movement and provide stability to the user. Alternatively, some user models can allow or be customized to allow tab movement to the front of the list.

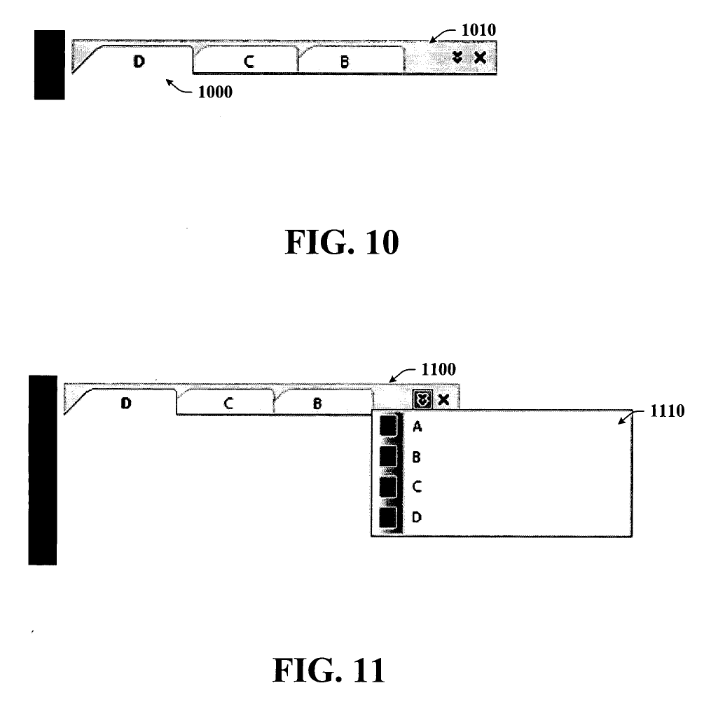

FIG. 10 illustrates the opening of File D 1000. File D 1000 is inserted on the left side of the channel 1010, given focus, and the other tabs are pushed to the right. Due to the limited channel length, Tab A 1020, the right-most tab 1020, has been bumped off the channel and can be accessed instead from the menu 1030. FIG. 11 shows that the three Tabs (e.g., B, C, and D) can now be seen in the channel 1100 as well as the four items (e.g., A, B, C, and D) in the menu 1110.

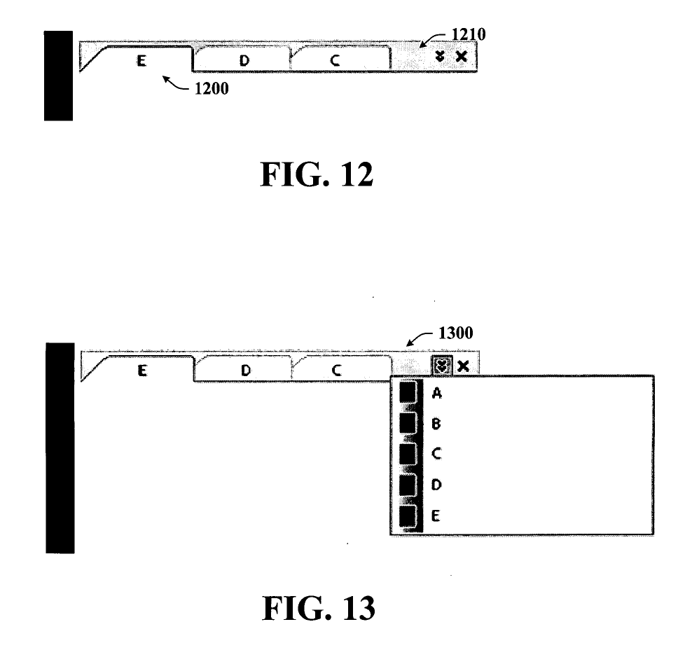

Next, File E 1200 is opened as depicted in FIG. 12. Again, File E 1200 is inserted on the left side of the channel 1210, the remaining tabs are shuffled right, and tab B has been bumped off the tab channel 1210. Tabs C, D, and E can now be seen in the channel 1300 according to FIG. 13. In addition, there are five items in the menu. On a 1024×768 display with a default window layout and 8 character file names, a user can see 9 tabs.

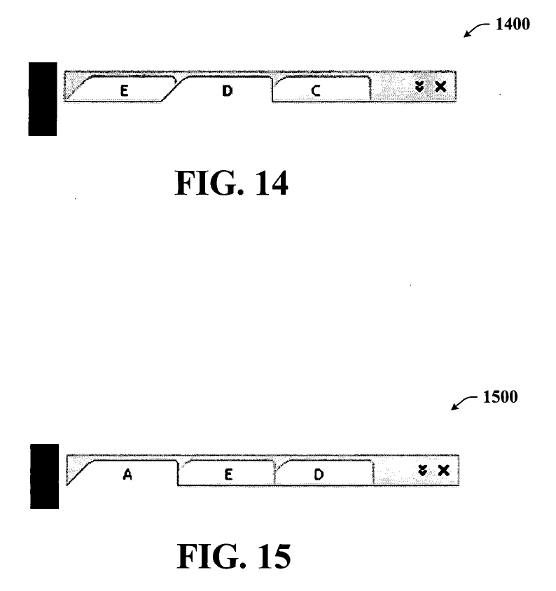

As illustrated in the diagram 1400 in FIG. 14, when a file that is visible in the tab channel is selected, that tab is selected, and no movement takes place. However, if a user were to manually move (e.g., zoom this file to the left, then a true MRU channel may result, but that would create a sense of instability. Hence, files which are not shown in the channel but are later accessed can then be added to the left of the channel. Otherwise, any tab in the channel retains its position—even when “active” (e.g., Tab D). When a file that is not visible in the tab channel is selected from the menu, that tab can be inserted at the left side of the tab channel as indicated in the diagram 1500 of FIG. 15. The remaining tabs are shuffled to the right, following the same pattern as if the file had not been opened.

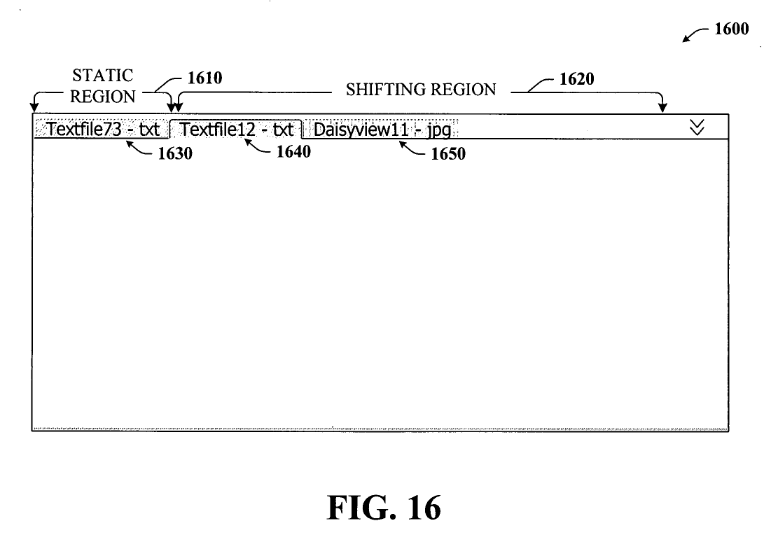

Turning now to FIG. 16, there is illustrated an exemplary user interface 1600 of a tab channel including both static 1610 and shifting 1620 regions. As can be seen, “Textfile73” 1630 is presently in the static region 1610 while “Textfile12” 1640 and “Daisyview11” 1650 are in the shifting region 1620. More than one scenario is possible to explain the appearance of the tab channel as depicted. For example, “Daisyview11” 1650 could have been opened first followed by “Textfile73” 1630—which may have been indicated for the static region 1610. Next, “Textfile12” 1640 entered the tab channel to the right of “Textfile73” 1630 but to the left of “Daisyview11” 1650. Alternatively, “Textfile73” 1630 entered first and was marked for the static region 1630. After, “Daisyview11” 1650 and “Textfile12” 1640 entered the tab channel in that order to the right “Textfile73” 1630. All other possible scenarios are contemplated to fall within the scope of the subject invention.

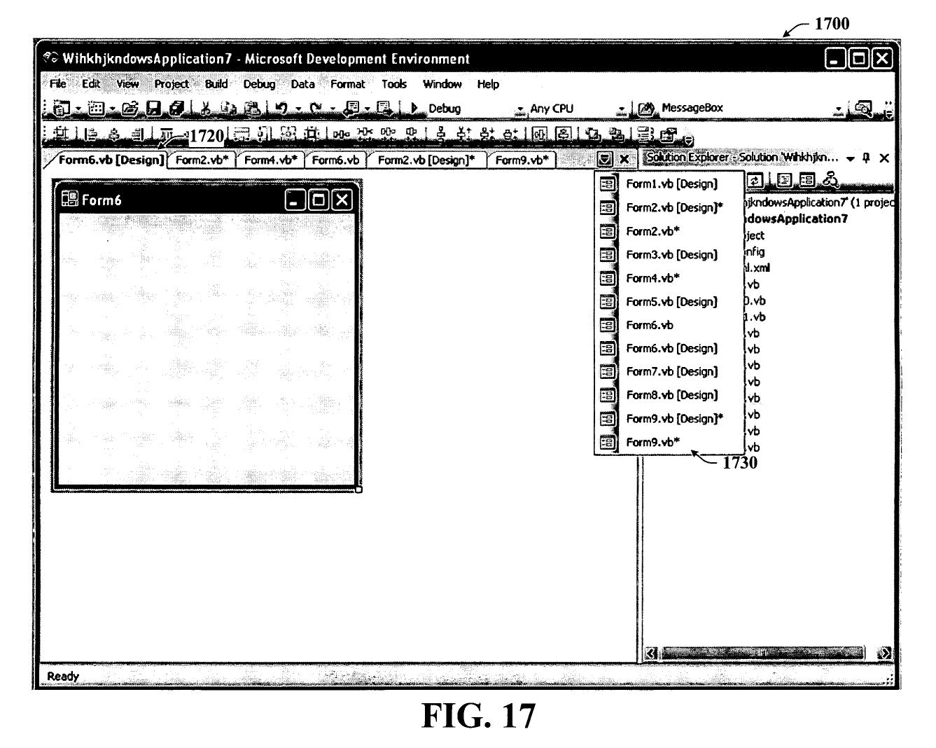

Referring to FIG. 17, there is illustrated a full screen view of an exemplary user interface 1700 of a workspace that includes a tab channel 1710. As shown, file “Form6.vb [Design]” 1720 appears on the far left side of the file tab channel and is the active file being viewed by a user. This means that the file Form6.vb was the most recently used/accessed/opened file. The file name indicated in the tab channel includes the file extension, content type (e.g., design), and a symbol or icon (e.g., asterisk) to indicate which files have been modified or modified and not saved since they were opened by the user.

The drop-down menu 1730 includes an alphabetical list of all open files. Thus, there is no need for users to readily determine which files are open or closed or where they exist on a partially hidden or scrolling tab channel. When a file is chosen for viewing from the menu and the file is not in the tab channel, then the file is inserted into the tab channel at the left side (of any file(s) in the shifting region).

Various methodologies in accordance with the subject invention will now be described via a series of acts, it is to be understood and appreciated that the invention is not limited by the order of acts, as some acts may, in accordance with the invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

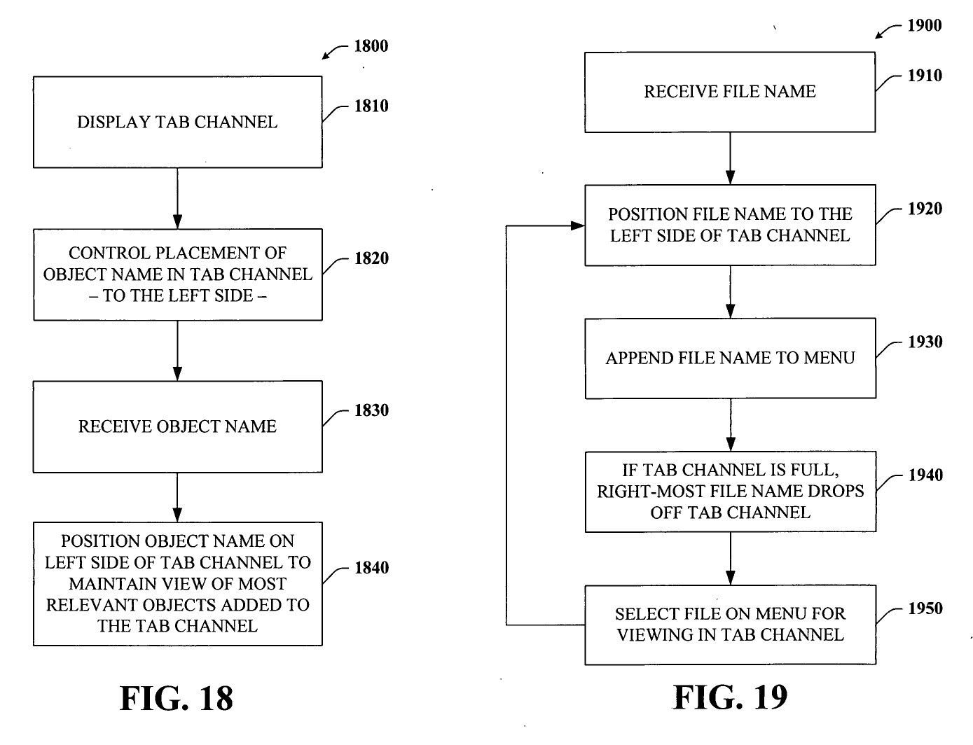

Referring now to FIG. 18, there is a flow diagram of an exemplary process 1800 that facilitates more efficient viewing and navigation of a large number of open objects such as documents, pictures, pages, sheets, etc. The process 1800 can begin with displaying the tab channel at 1810. At 1820, placement of an object name for any objects opened can be controlled or determined in part according to user preference to optimize navigation and viewing of the objects. At 1830, an object name can be received from the user and then positioned on the left side of the tab channel at 1840 to facilitate maintaining a view of the most relevant objects added to the tab channel.

In FIG. 19, there is a flow diagram of an exemplary process 1900 that facilitates more efficient viewing and navigation of a large number of open files. The process 1900 involves receiving an incoming file name at 1910 and then positioning the file name to the left side of a tab channel for easier navigation between open files. At 1930, the file name can be appended to a menu in an ordered manner such as alphabetically or chronologically (when initially opened by the user). At 1940, if the tab channel is full, a right-most file name is dropped off of the channel to make room for the incoming file name. Following, a user may then decide to select a file that is only viewable in the menu at 1950. The process can then return to 1920, wherein the file name is inserted to the left side of the tab channel.

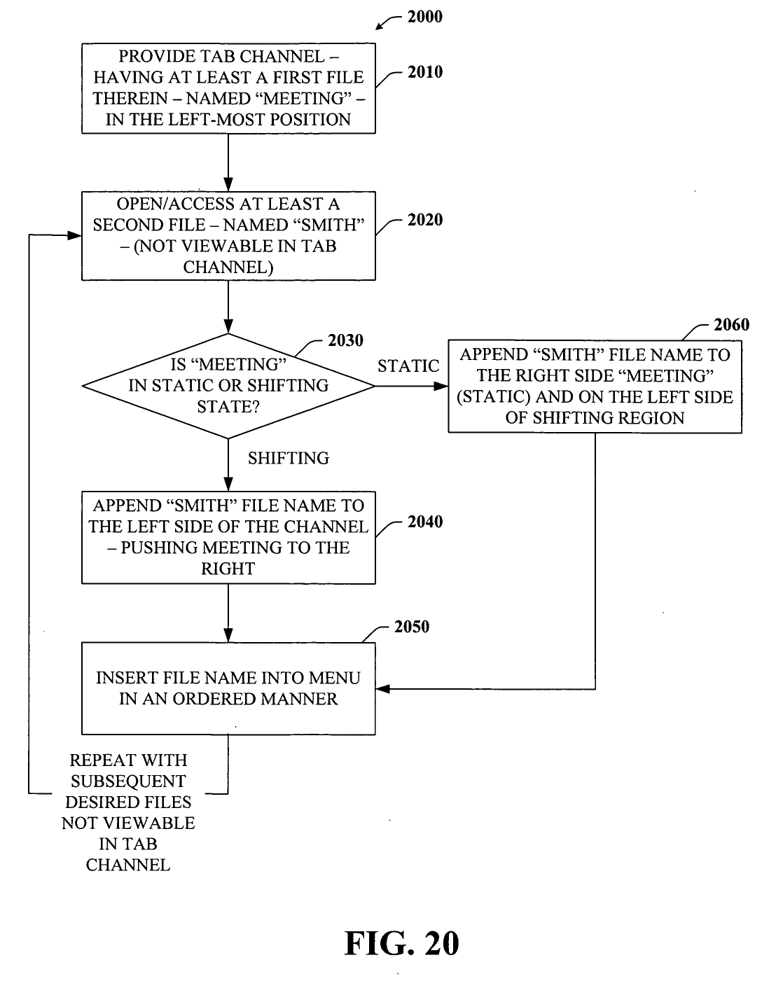

Turning now to FIG. 20, there is a flow diagram of an exemplary 2000 that facilitates customization of a tab channel to further enhance the viewing and navigation between a large number of files. The process 2000 can involve providing a tab channel having at least a first file at a left position of a tab channel at 2010. Imagine that the file is named Meeting. At 2020, at least a second file named Smith for example can be opened or accessed for viewing (in the tab channel as well as in a workspace or window). At 2030, it can be determined whether the at least first file Meeting is in a shifting or static region of the tab channel. If Meeting is in the shifting region of the tab channel at 2030, then Smith can be added to the left of Meeting at 2040, thereby pushing Meeting to the right in the tab channel. At or about the same time, Smith can be added to a menu that lists all open files at 2050. However, if Meeting is in a static region in the tab channel, then Smith can be added to the right of Meeting but to the left of any other file in the shifting channel at 2060. Thus, Smith is still inserted at the left side of the shifting region. Again, the file name is added to the menu at 2050. This process can be repeated as necessary for any other files not already visible in the tab channel. Files in the tab channel can be selected at least one at time to be viewed in greater detail in the corresponding workspace or window.

Moreover, the more relevant files can be maintained to the left side of a tab channel and the less relevant files (as determined by the user) can be gradually moved to the right side of the tab channel. As the tab channel fills up, previously opened/accessed can ultimately be dropped off of the channel. Fortunately, such files are still readily accessible via a menu within the user's visible workspace. Thus, the user is not unduly inconvenienced by having to scroll across a large quantity of files to find a file that was opened earlier in the day. Rather, the file can simply be found on the menu—when no longer found in the tab channel.

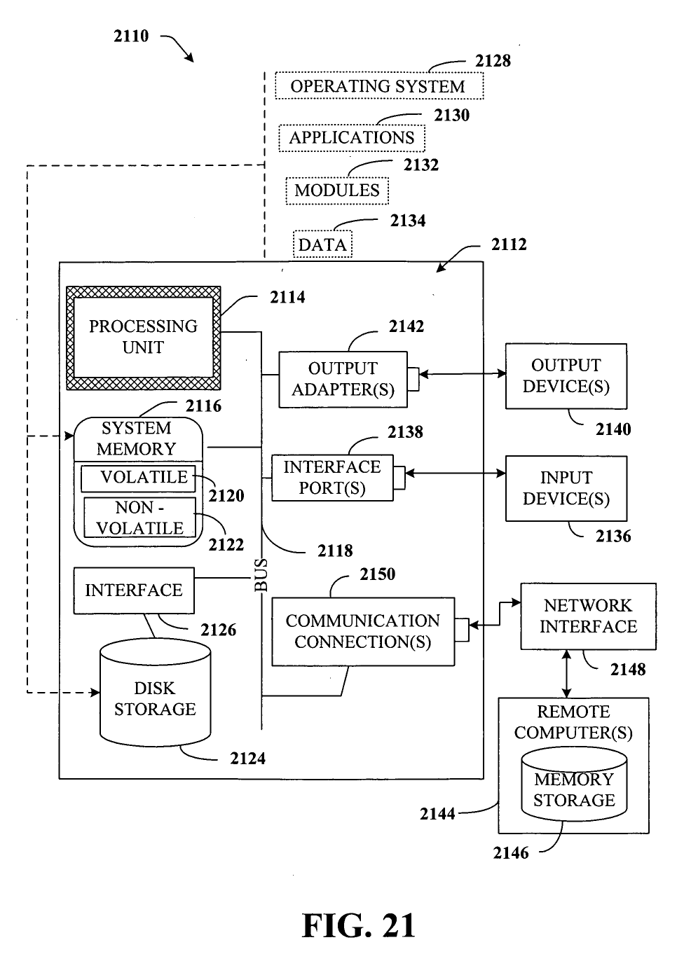

In order to provide additional context for various aspects of the invention, FIG. 21 and the following discussion are intended to provide a brief, general description of a suitable operating environment 2110 in which various aspects of the subject invention may be implemented. While the subject invention is described in the general context of computer-executable instructions, such as program modules, executed by one or more computers or other devices, those skilled in the art will recognize that the subject invention can also be implemented in combination with other program modules and/or as a combination of hardware and software.

Generally, however, program modules include routines, programs, objects, components, data structures, etc. that perform particular tasks or implement particular data types. The operating environment 2110 is only one example of a suitable operating environment and is not intended to suggest any limitation as to the scope of use or functionality of the subject invention. Other well known computer systems, environments, and/or configurations that may be suitable for use with the subject invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 21, an exemplary environment 2110 for implementing various aspects of the subject invention includes a computer 2112. The computer 2112 includes a processing unit 2114, a system memory 2116, and a system bus 2118. The system bus 2118 couples system components including, but not limited to, the system memory 2116 to the processing unit 2114. The processing unit 2114 can be any of various available processors. Dual microprocessors and other multiprocessor architectures also can be employed as the processing unit 2114.

The system bus 2118 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 2116 includes volatile memory 2120 and nonvolatile memory 2122. The basic input/output system (BIOS), containing the basic routines to transfer information between elements within the computer 2112, such as during start-up, is stored in nonvolatile memory 2122. By way of illustration, and not limitation, nonvolatile memory 2122 can include read only memory (ROM), programmable ROM (PROM), electrically programmable ROM (EPROM), electrically erasable ROM (EEPROM), or flash memory. Volatile memory 2120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2112 also includes removable/nonremovable, volatile/nonvolatile computer storage media. FIG. 21 illustrates, for example a disk storage 2124. Disk storage 2124 includes, but is not limited to, devices like a magnetic disk drive, floppy disk drive, tape drive, Jaz drive, Zip drive, LS-100 drive, flash memory card, or memory stick. In addition, disk storage 2124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 2124 to the system bus 2118, a removable or non-removable interface is typically used such as interface 2126.

It is to be appreciated that FIG. 21 describes software that acts as an intermediary between users and the basic computer resources described in suitable operating environment 2110. Such software includes an operating system 2128. Operating system 2128, which can be stored on disk storage 2124, acts to control and allocate resources of the computer system 2112. System applications 2130 take advantage of the management of resources by operating system 2128 through program modules 2132 and program data 2134 stored either in system memory 2116 or on disk storage 2124. It is to be appreciated that the subject invention can be implemented with various operating systems or combinations of operating systems.

A user enters commands or information into the computer 2112 through input device(s) 2136. Input devices 2136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2114 through the system bus 2118 via interface port(s) 2138. Interface port(s) 2138 include, for example, a serial port, a parallel port, a game port, and a universal serial bus (USB). Output device(s) 2140 use some of the same type of ports as input device(s) 2136. Thus, for example, a USB port may be used to provide input to computer 2112 and to output information from computer 2112 to an output device 2140. Output adapter 2142 is provided to illustrate that there are some output devices 2140 like monitors, speakers, and printers among other output devices 2140 that require special adapters. The output adapters 2142 include, by way of illustration and not limitation, video and sound cards that provide a means of connection between the output device 2140 and the system bus 2118. It should be noted that other devices and/or systems of devices provide both input and output capabilities such as remote computer(s) 2144.

Computer 2112 can operate in a networked environment using logical connections to one or more remote computers, such as remote computer(s) 2144. The remote computer(s) 2144 can be a personal computer, a server, a router, a network PC, a workstation, a microprocessor based appliance, a peer device or other common network node and the like, and typically includes many or all of the elements described relative to computer 2112. For purposes of brevity, only a memory storage device 2146 is illustrated with remote computer(s) 2144. Remote computer(s) 2144 is logically connected to computer 2112 through a network interface 2148 and then physically connected via communication connection 2150. Network interface 2148 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2150 refers to the hardware/software employed to connect the network interface 2148 to the bus 2118. While communication connection 2150 is shown for illustrative clarity inside computer 2112, it can also be external to computer 2112. The hardware/software necessary for connection to the network interface 2148 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates viewing multiple file objects comprising:
a display component that displays information to a user within a viewable navigation space;
a directional navigation component that controls placement of open file objects with respect to the viewable navigation space; and
an input component that receives user input and communicates it to the directional navigation component to facilitate determining an initial placement of a recently opened file object in the viewable navigation space.

2. The system of claim 1, the display component comprises an object tab channel that spatially arranges a plurality of objects in a unidirectional manner based at least in part upon when the file objects are opened.

3. The system of claim 2, the directional navigation component positions at least a first newly opened object to a left side of the object tab channel.

4. The system of claim 3, further comprising at least a second newly opened object that is positioned to the left of the first object such that most recently opened objects are placed to the left of the viewable navigation space.

5. The system of claim 1, further comprising a resource menu component that at least temporarily maintains at least a partial list of open files in an ordered manner.

6. The system of claim 5, the directional navigation component pushes at least one object to a right side of the channel when an incoming object enters the left side of the channel.

7. The system of claim 5, the directional navigation component moves an object selected from the resource menu component to the object tab channel when the object is not viewable in the object tab channel.

8. The system of claim 7, the object is moved to a left-side of the object tab channel.

9. The system of claim 7, the object is moved to a position left of any other objects located in the object tab channel.

10. The system of claim 1, the object tab channel comprises a shifting region, the shifting region comprising a plurality of objects that are temporarily visible in the tab channel.

11. The system of claim 10, wherein the objects in the shifting region are pushed to the right of the shifting region as incoming objects enter the shifting region from the left.

12. The system of claim 1, the object tab channel comprises a static region whose position is fixed in the tab channel, the static region comprising at least one object.

13. The system of claim 1, the object tab channel comprises at least one object name tab, the object name tab comprising at least one of the object name and object type.

14. The system of claim 13, the object name tab further comprises at least one of a color and a symbol to denote at least one state of the object.

15. The system of claim 14, the at least one state comprising at least one of the following:
subject;
project;
modified;
modified but not saved; and
object owner.

16. A method that facilitates viewing and navigating between multiple objects comprising:
displaying at least one tab channel;
receiving at least one object name for addition to the tab channel; and
inserting the object name on a left side of the tab channel to maintain a view of more relevant objects as they are added to the tab channel.

17. The method of claim 16, inserting the object name to the left side of any other object names previously inserted in the tab channel.

18. The method of claim 16, inserting the object name to the left side of a shifting region in the tab channel.

19. The method of claim 16, further comprising inserting the object name to a static region in the tab channel.

20. The method of claim 19, further comprising subsequently inserting at least a second object name in the tab channel.

21. The method of claim 20, the second object name is inserted in one of the following manners:
on the left side of the shifting region and to the right of the static region; and
into the static region and to the left of the shifting region.

22. The method of claim 16, wherein inserting the object name on a left side of the tab channel to maintain a view of more relevant objects as they are added to the tab channel pushes any other object names already present in the tab channel to the right.

23. The method of claim 22, further comprising dropping off object names as they reach a right end point of the table channel to make room for incoming object names on the left side of the tab channel.

24. The method of claim 16, further comprising controlling placement of at least one object name in the tab channel.

25. A method that facilitates navigation of multiple open files comprising:
providing at least one tab channel on a user interface;
opening at least one file for viewing; and
appending the at least one file to a left side of the tab channel.

26. The method of claim 25, after appending the at least one file to the left side of tab channel, pushing any other files to the right in the tab channel when there is already at least one other file in the tab channel.

27. A user interface that facilitates navigation of multiple open files comprising:
a navigation channel that comprises one or more tabs corresponding to respective open files; and
a resource menu that communicates with the navigation channel, the resource menu comprising a listing of open files at least according to file name.

28. The user interface of claim 27, the navigation channel comprises at least a shifting region that displays file names on a temporary basis.

29. The user interface of claim 26, the navigation channel further comprises a static region that displays file names on a more permanent basis and remains in a fixed position to the left of the shifting region.

30. A data packet adapted to be transmitted between two or more computer processes facilitating more efficient navigation of multiple open objects, the data packet comprising information related to or generated in part from displaying at least one tab channel on a user interface; opening at least one file for viewing; and appending the at least one file to a left side of the tab channel and pushing other files in the channel to the right when present.

31. A computer readable medium having stored thereon the computer executable components of the system of claim 1.

32. A navigational system that facilitates navigating between multiple open objects comprising:
means for providing at least one tab channel on a user interface;
means for opening at least one file for viewing; and
means for appending the at least one file to a left side of the tab channel.

33. The system of claim 32, further comprising a means for pushing any other files to the right in the tab channel when there is already at least one other file in the tab channel.
